(19) United States
(12) Patent Application Publication
(10) Pub. No.: US 2008/0059748 A1
(43) Pub. Date: Mar. 6, 2008

(54) Method, mobile device, system and software for a write method with burst stop and data masks

(75) Inventors: Jani J. Klint, Kangasala (FI); Matti Floman, Kangasala (FI); Aarne Heinonen, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/897,963

(22) Filed: Aug. 31, 2007

Related U.S. Application Data
(60) Provisional application No. 60/842,196, filed on Aug. 31, 2006.

(51) Int. Cl. G06F 12/00; G06F 13/28

(52) U.S. Cl. 711/167; 710/35

(57) ABSTRACT

A method, mobile device, system, and software are devised in order to implement a write method that includes two different types of write commands, depending upon the length of a data burst to memory. A first write command is provided for a first type of burst and/or a second write command is provided for a second type of burst. The first type of burst is a burst of substantially a certain length. The second type of burst has length that is substantially an integer multiple of the length of the first type of burst, such as two or four times the length of the first type of burst.

### CROSS-REFERENCE TO RELATED APPLICATION

This application claim priority to U.S. Provisional Application 60/842,196 filed Aug. 31, 2006.

### FIELD OF THE INVENTION

The invention relates to memories, and more particularly relates to transferring information to a memory via a memory interface.

### BACKGROUND OF THE INVENTION

Computer memories have normally been designed to use one memory device for each bit, or for each small group of bits, of any individual computer word. The word size is governed by the choice of computer, and word sizes typically have ranged from 4 to 64 bits. Thus, each memory device is usually connected to one of a series of data lines. One or more devices may be connected to each data line, but typically only a small number of data lines are connected to a single memory device. Data is thus accessed (i.e. read) or provided (i.e. written) in parallel, for each memory read or write operation, respectively.

Different memory access techniques use various burst lengths for providing optimum performance of each application. For example, graphics require short bursts, whereas cache-filling uses long bursts. However, if only short or long bursts are used, then power and performance are necessarily lost.

The RAMBUS company has defined a method which defines burst length at the same time as burst access is performed. The RAMBUS method is limited to predefined burst lengths having multiples of 2. A pair of RAMBUS patents are incorporated herein by reference: Farmwald I (U.S. Pat. No. 6,032,214), and Farmwald II (U.S. Pat. No. 6,034,918). Incidentally, those two patents refer to the burst length as “block size.”

It is well known that memory can have a predefined burst length, which is typically a multiple of 2 (e.g. 2, 4, 8 or 16), as in the aforementioned RAMBUS patents. If a memory bus executes fast, then it is important to give the memory a maximum time to fetch the right amount of data for optimum performance and power consumption. A known way to do this is to select, from certain fixed values, one particular value that will be used during a burst, before making burst access, or while burst access is performed (as in Farmwald I and II).

It is also known to have a continuous burst without limit, and to stop this kind of continuous burst with a command in a command bus. According to such a method, a burst stop (BST) command is given when it is desired to stop the burst. Unfortunately, that method causes empty clocks regarding the data bus, at least in case of Dynamic Random Access Memory (DRAM) busses. A continuous burst stop is described, for example, in a document from MICRON TECHNOLOGY, INC. titled “Mobile Double Data Rate (DDR) SDRAM,” which is also incorporated herein by reference. The MICRON document refers to a continuous burst stop as a “burst terminate (BST)”.

Data mask signaling is often used in case of a write operation, and data mask signaling has also been used for read operations in a DRAM environment. The status of a data mask pair indicates whether data on the bus is valid or should instead be ignored. Unfortunately, that method does not remove invalid data from the bus, and leaving invalid data in the bus causes the problem that data bus cycles are lost.

Some of these problems are addressed by pending U.S. Provisional Application 60/779,269 titled “Method, Mobile Device, System and Software for Flexible Burst Length Control” (filed 2 Mar. 2006) which is incorporated in its entirety by reference herein. However, that pending application still leaves some challenges with respect to several byte masking cases. Although that pending application uses data masks for burst stop, a new method is needed to overcome the challenges regarding some of the masking cases. That pending application provided flexible burst length for write and read to achieve optimum performance, and that method can still be used, but supplementary improvements are needed.

### SUMMARY OF THE INVENTION

The present invention discloses a way to have flexible burst length for write operations of RAM or memories with similar functionality. In particular, an improved write method for DRAM-type execution memory is presented. In combination with earlier known methods, the present invention allows full masking functionality like word masking.

According to this invention, the memory will always use a continuous burst or maximum supported burst length (which can be stopped). The method of the present invention is especially useful for allowing flexible burst length with a fast memory interface.

Thus, an unspecified burst length can be used until the burst is stopped, or alternatively a maximum burst length could be used (e.g. 16) but is stopped in case of a shorter burst. The stop method can be accomplished, for example, by reusing data mask signals to indicate when data is supposed to be stopped

### BRIEF DESCRIPTION OF THE DRAWINGS

FIG. 1 shows how a mask signal operates in case of a short burst and prefetch 2.

FIG. 2 shows a short burst followed with long burst (prefetch 4).

FIG. 3 is a flow chart showing a method according to an embodiment of the present invention.

FIG. 4 is a block diagram illustrating a system according to an embodiment of the present invention.

### DETAILED DESCRIPTION OF THE INVENTION

A preferred embodiment of the present invention will now be described, merely to illustrate one way of implementing the invention, and without limiting the scope or coverage of what is described elsewhere in this application.

According to this embodiment, a new write command is introduced, and an existing write command's functionality is redefined. This means that a first write command is used for a short burst (e.g. length of prefetch such as 4), and another write command is used for a longer burst which are multiples (N>1) of the prefetch (e.g. 8 or 16).

A memory controller can use mask functionality only with the short burst. Conversely, the bus stop can only be used for the long burst.

Compared to previous behavior, the mask signal is now advanced so that it optimally has one clock latency, and also other values are possible, such as two clocks. This way, conflicts between two meanings of byte mask pins cannot exist, since potential mask signals for a short burst do not occur when the stop signal could be active.

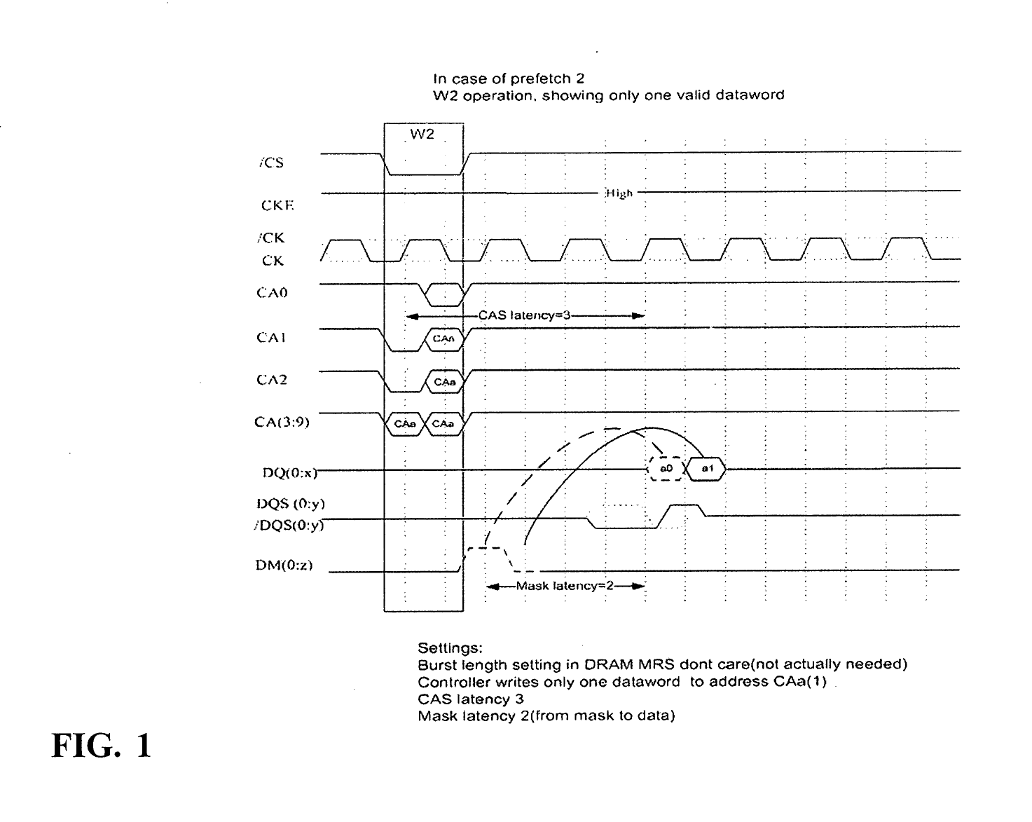

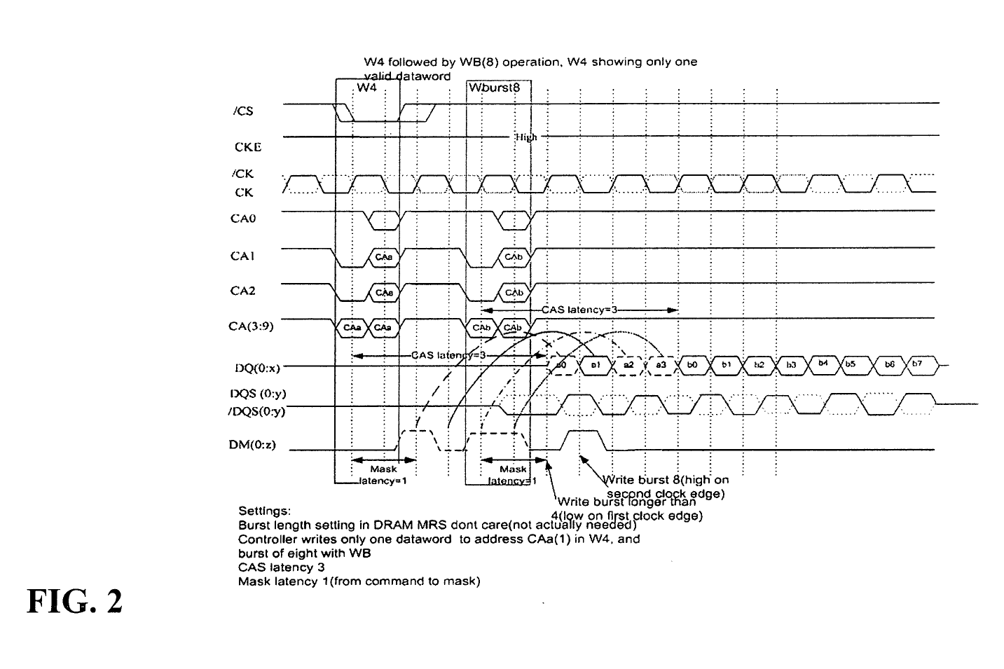

As seen in FIG. 1, a mask signal operates in case of a short burst and prefetch 2, according to an embodiment of the present invention. In contrast, FIG. 2 shows a short burst followed with long burst (prefetch 4) according to an embodiment of the present invention.

Instead of introducing a new command, it is thus possible to separate different write cases with a parameter which indicates data mask usage (i.e. allowed or not allowed). Advantages of this embodiment include bringing all combined advantages of earlier technology to bear on all use cases. That includes optimum power and performance. The performance benefit comes also from improved data mask operations. In other words, during the write, no useless data cycles are needed. Furthermore, there are no additional pins, and no command cycles are lost (in case of signal or calculation-based methods).

The present invention can operate in conjunction with at least four related types of burst length control. Each of these four implementations attains the same principle functionality.

The first of the four implementations is a signal-based method. In an optimized controller, one of the data mask signals (or alternatively some other additional/existing signal) is used to indicate to the memory a time of column address strobe (tCAS) before which the data bus must be released. The tCAS indicates the time (e.g. number of clock cycles) needed to access valid data on the data bus. However, the tCAS time is a minimum, and in some cases it makes sense to have available a longer duration for providing more time for the memory to act. In case of very fast buses and over-optimized performance, it can be useful to provide an additional write burst stop with read or write, since it is possible to have a timing conflict for usage of the mask signal in this case, or power/performance might be lost because of a stop indication that is too late (e.g. memory is already started next fetching).

The second of the four implementations is a register-based method. This method could be understood as advanced burst stop, used already in DRAMs. The novelty of this implementation resides in predefining the time, once a stop indication arrives, and a register for storing this time is needed. The way to indicate a burst stop can be either a command, or a register write, or even a signal.

The third of the four implementations is a calculation-based implementation. In this method, the memory has a capability to recognize when a counter starts (i.e. some command starts the counter), and to recognize when the counter stops due to commands or addresses. This counter value would then indicate how many data cycles are needed. For example, an indication of a start could be a row address which comes with a row activate command and a finishing column address which comes with a read or write command, or in case of column-only then a column address could be split into two or even more cycles. The challenge for this method is that for different burst lengths there would be different times, e.g. in case of address; counter start and stop commands time interval is predefined by the needed burst length, therefore making the bus usage more complicated.

The fourth of the four implementations is an enhanced signal-based method. In an optimized controller, one of the data mask signals (or alternatively some other additional/existing signal) is used to indicate to the memory a time which defines when the data bus must be released. In this implementation, the memory calculates rising clock edges from a read/write command (falling edges could be used as well but then of course the formula is different). The result of this calculation is then used in a formula, such as 2 to the power of sum, or 2 times the sum. This formula could be used also with the calculation-based implementation. According to that formula, if a burst length of 8 is desired, for instance, then 3 rising edges would be provided. This method could be enhanced: e.g. the calculation could start from 2, 4 or something else. In case of starting from 2, one calculated rising edge would result in a burst length of four. This implementation gives the longest time for the memory to behave properly. Among these four implementations, the signal-based methods are likely to provide the best implementation, especially if it is a data-mask signal-based implementation in a case like the DRAM case.

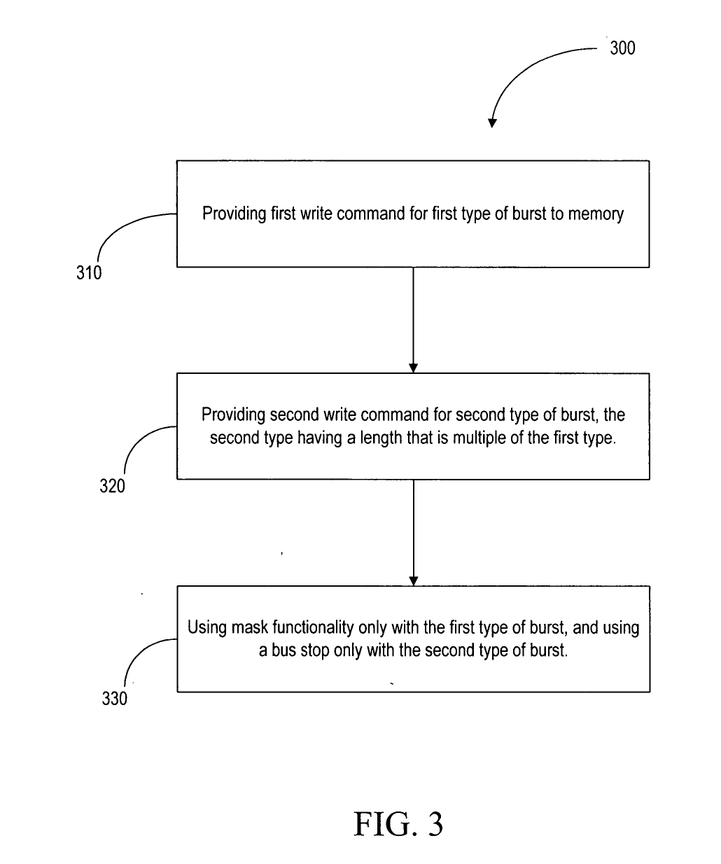

According to the flow chart 300 of FIG. 3, a first write command is provided 310 for a first type of burst to memory. Then a second write command is provided 320 for a second type of burst to memory, the second type having a length that is an integer multiple of the first type. Mask functionality is used 330 only with the first type of burst in this embodiment.

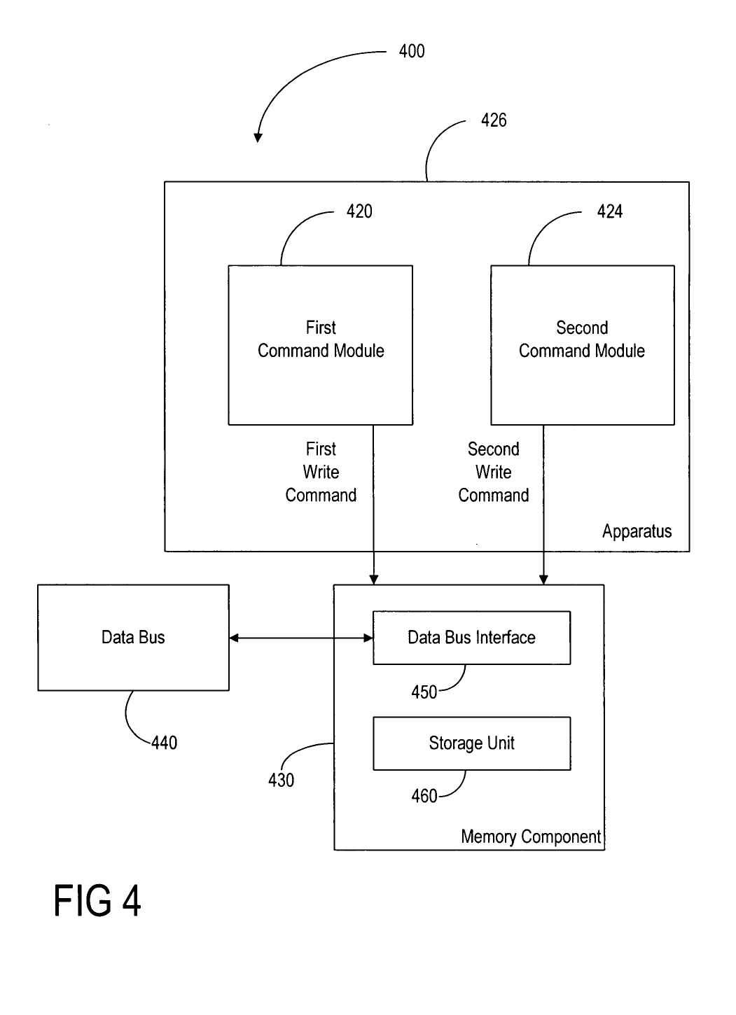

Turning now to the system 400 of FIG. 4, a data bus 440 communicates with a memory component 430. An apparatus 426 includes a first command module 420 which is configured to provide a first write command to use a first type of burst for writing to a storage unit 460 of a memory component 430, via a data bus interface 450. The apparatus 426 also includes a second command module 424 which is configured to provide a second write command to use a second type of burst for writing to the memory 430. The second type of burst has a length that is an integer multiple of the first type.

The present invention can be implemented using a general purpose or specific-use computer system, with program code conforming to the method described herein. The program code is designed to drive the operation of the particular hardware of the system, and to be compatible with other system components and I/O controllers. The computer system of this embodiment may include a CPU processor, comprising a single processing unit, or multiple processing units capable of parallel operation, or the processor can be distributed across one or more processing units in one or more locations, e.g., on a client and server. The memory containing the memory component 430 may comprise any known type for data storage, including magnetic media, optical media, random access memory (RAM), read-only memory (ROM), a data cache, a data object, etc. Moreover, the memory may reside at a single physical location, comprising one or more types of data storage, or be distributed across a plurality of physical systems in various forms.

It is to be understood that the present figures, and the accompanying narrative discussions of best mode embodiments, do not purport to be completely rigorous treatments of the method, system, apparatus, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method comprising:
providing a first write command to use a first type of burst for writing to a memory; or
providing a second write command to use a second type of burst for writing to the memory;
wherein the second type of burst has length that is substantially an integer multiple of a length of the first type of burst.

2. The method of claim 1, wherein mask functionality is used only with the first type of burst.

3. The method of claim 1, wherein the first command and the second command are both provided, in either order.

4. The method of claim 1, wherein a bus stop is used only with the second type of burst.

5. The method of claim 4, wherein mask signals for a first burst end once the bus stop is activated.

6. The method of claim 5, wherein at least one of the mask signals has one clock latency.

7. The method of claim 1, wherein different write cases are separated with a parameter which indicates data mask usage.

8. An apparatus comprising:
means for providing a first write command to use a first type of burst for writing to a memory; and
means for providing a second write command to use a second type of burst for writing to the memory;
wherein the second type of burst has length that is substantially an integer multiple of a length of the first type of burst.

9. The apparatus of claim 8, wherein mask functionality is used only with the first type of burst.

10. The apparatus of claim 8, wherein a bus stop is used only with the second type of burst.

11. The apparatus of claim 10, wherein mask signals for a first burst end once the bus stop is activated.

12. The apparatus of claim 11, wherein at least one of the mask signals has one clock latency.

13. An apparatus comprising:
a first command module configured to provide a first write command to use a first type of burst for writing to a memory; and
a second command module configured to provide a second write command to use a second type of burst for writing to the memory;
wherein the second type of burst has length that is substantially an integer multiple of a length of the first type of burst.

14. The apparatus of claim 13, wherein mask functionality is used only with the first type of burst.

15. The apparatus of claim 13, wherein a bus stop is used only with the second type of burst.

16. The apparatus of claim 13, wherein mask signals for a first burst end once the bus stop is activated.

17. The apparatus of claim 13, wherein at least one of the mask signals has one clock latency.

18. A software product comprising a computer readable medium having executable codes embedded therein; the codes, when executed, adapted to carry out the functions of:
providing a first write command to use a first type of burst for writing to a memory; or
providing a second write command to use a second type of burst for writing to the memory;
wherein the second type of burst has length that is substantially an integer multiple of a length of the first type of burst.

19. The software product of claim 18, wherein mask functionality is used only with the first type of burst.

20. The software product of claim 18, wherein a bus stop is used only with the second type of burst.

21. The software product of claim 20, wherein mask signals for a first burst end once the bus stop is activated.

22. The software product of claim 19, wherein at least one of the mask signals has one clock latency.

23. A system comprising:
a first command module configured to provide a first write command to use a first type of burst for writing to a memory; and
a second command module configured to provide a second write command to use a second type of burst for writing to the memory;
wherein the second type of burst has length that is substantially an integer multiple of a length of the first type of burst.

24. The system of claim 23, wherein mask functionality is used only with the first type of burst.

25. The system of claim 23, wherein a bus stop is used only with the second type of burst.
